(19) United States
(12) Patent Application Publication
(10) Pub. No.: US 2024/0241572 A1
(43) Pub. Date: Jul. 18, 2024

(54) Real time capture of transient emotions for subsequent analysis

(71) Applicant: Wayne Gerard Poole, Alexandria, VA (US)

(72) Inventor: Wayne Gerard Poole, Alexandria, VA (US)

(21) Appl. No.: 17/803,897

(22) Filed: Jan. 17, 2023

(51) Int. Cl. G06F 3/01; G06F 1/16; G08B 25/01

(52) U.S. Cl. CPC G06F 3/011; G06F 1/163; G08B 25/016; G06F 2203/011

(57) ABSTRACT

A system for capturing aspects of emotions in real time, and distributes associated data is shown and described. Each monitored subject wears on the body apparatus providing easy entry of data, such as via pushbuttons, one to identify a particular emotion being reported, and a second to report perceived intensity of the emotion. Pushbutton inputs are transmitted as data wirelessly, first to a cellular phone of each subject, and then to a central station. One or more authorized analysts may access the data, sent secured by block chain protocol and presented anonymously as avatars. Optionally, in addition to or instead of transmission of data to a human therapist, data may be transmitted to a remote self-help assistant, such as a downloaded program on a computer or stored on the cellular phone.

### FIELD OF THE INVENTION

The present invention relates to data capture and dissemination for analysis, and more particularly, to apparatus and methods enabling individuals to facilely record their own moods and psychological states for subsequent data compilation and analysis.

### BACKGROUND OF THE INVENTION

Emotional cycles are correlated with achievement of life goals. These may be assessed by therapeutic professionals and others to assist an individual to attainment of goals. For example, it may be of interest to identify recurring emotions as to depth of experienced emotions and frequency thereof, to help an individual to understand psychologically caused impediments to attainment of goals. There exists a need for a system that captures aspects of emotions in real time, and transmits captured aspects as data for remote analysis.

### SUMMARY OF THE INVENTION

The present invention sets forth a system which captures aspects of emotions in real time, and distributes associated data such that emotions of one or of many people can be distributed to a plurality of analysts while preserving anonymity of the subjects of study. To this end, each monitored subject wears on his or her body apparatus providing easy entry of data. Entry is performed for example by depressing pushbuttons, one to identify a particular emotion being reported, and a second to report perceived intensity of the emotion. Pushbutton inputs are transmitted as data wirelessly, first to a cellular phone of each subject, and then by telephonic communications to a central station. Data stored at the central station can be accessed by one or more analysts. The analysts may then consider data of one particular subject, for example a therapist monitoring a patient, or alternatively, analysts studying groups may access the data of more than one subject.

Data may be protected by block chain protocol. Data of individuals may be cloud stored using the internet and distributed over the internet, and graphically presented on screen to authorized analysts as anonymous avatars, with one-on-one communications between an analyst and a patient foregoing anonymity. Authorization of specific analysts may be via subscription to a service or in other ways.

Optionally, in addition to or instead of transmission of data to a human therapist, data may be transmitted to a remote self-help assistant, such as a downloaded program on a computer or stored on the cellular phone.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic representation of apparatus for implementing a method of capturing in real time, data pertaining to transient emotions and transmitting the data remotely for compilation and analysis;

FIG. 2 is a plan view of exemplary embodiments of an apparatus element shown at the upper left of FIG. 1;

FIG. 3 is a schematic of functional elements of the apparatus element shown at the upper left of FIG. 1.

### DETAILED DESCRIPTION

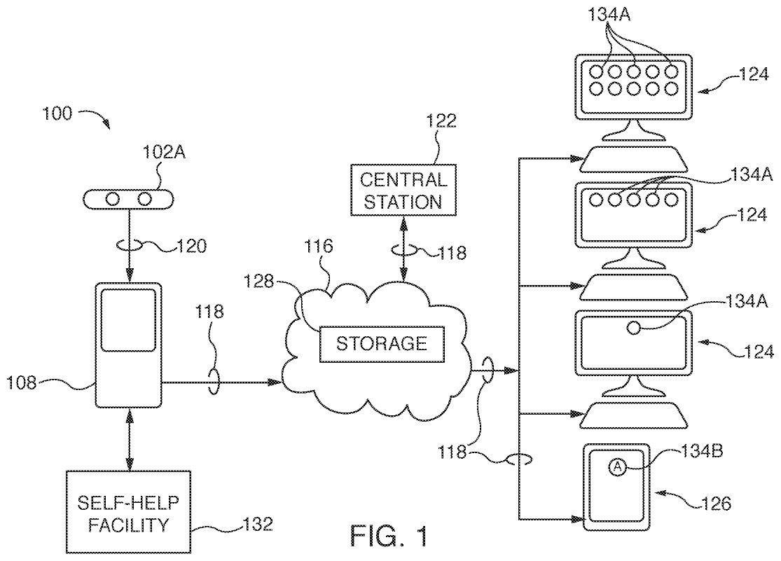

Referring first to FIG. 1, according to at least one aspect of the invention, there is shown a system 100 for implementing a method of capturing, in real time, data pertaining to transient emotions, and transmitting the data remotely for compilation and analysis. The system may comprise, for each of the human subjects, a body worn input device such as a ring 102A operable by haptic manipulation. The body worn input device may comprise a bracelet 102B, a necklace and pendant 102C, or may take other forms. Also referring to FIG. 3, the body worn input device may include a first interface element, such as a pushbutton 104 on body worn input device 102A, 102B, or 102c operable to record a nature of an emotion, and a second interface element 104 on body worn input device 102A, 102B, or 102C, operable to record intensity characteristics of the emotion. Alternatively stated, first interface element 104 and second interface element 104 may each comprise a respective pushbutton accessible from an outer surface of the body worn input device.

In one option for use, interface element 104 used to signal an emotion may be depressed once to designate one emotion, twice to designate a second emotion, and additional times to indicate still other emotions. Second interface element 104 may be depressed once to indicate a low level of intensity of the selected emotion, depressed twice to indicate an intermediate level of intensity, and more to indicate stronger levels of intensity.

System 100 may also include a low powered wireless communications apparatus 106 (FIG. 3), such as one using Bluetooth standard operable to transmit data to a cellular phone 108 (FIG. 1), a microprocessor 110 (FIG. 3) to manage functions, circuitry 112 (FIG. 3) connecting first interface element 104 and second interface element 104 to low powered wireless communications apparatus 106, and a battery cell 114 (FIG. 3) electrically connected to supply operating power to circuitry 112. Circuitry 112, shown only diagrammatically, will be understood to include a number and arrangement of conductors necessary to carry out described functions, as well as other components such as electrical insulation of conductors, connectors, circuit protective features such as fuse(s) and/or circuit breaker(s) (none of the other components are shown), etc.

System 100 may include a personal communications device (such as cellular phone 108) operable to communicate via a telecommunications network, such as a commercial telephone system (not separately shown), the internet 116, a virtual private network (VPN) (not separately shown), or any combination of these. In FIG. 1, the telecommunications network and VPN are represented by lines 118 (FIG. 3) indicating flow of data. Low powered data transmission from the body worn input device to cellular phone 108 is represented as line 120 (FIG. 1).

System 100 may include a central station 122 (FIG. 1) communicably connected to the communications network and having microprocessor and memory (not separately shown) operable to record data received from each of the personal communications devices, to receive requests, authenticate authorization of a source of each of the requests, and to transmit data through the telecommunications network with block chain protection. System 100 may comprise at least one communications device, such as a personal computer (PC) 124 ((FIG. 1) or cellular phone 126 (FIG. 1), in communication with the telecommunications network and capable of generating a said request for data. The communications device exemplified by PC 124 and cellular phone 126 is in possession of a researcher or analyst desiring to access data gathered by system 100 and stored in cloud storage 128 (FIG. 1) or central station 122 (or both).

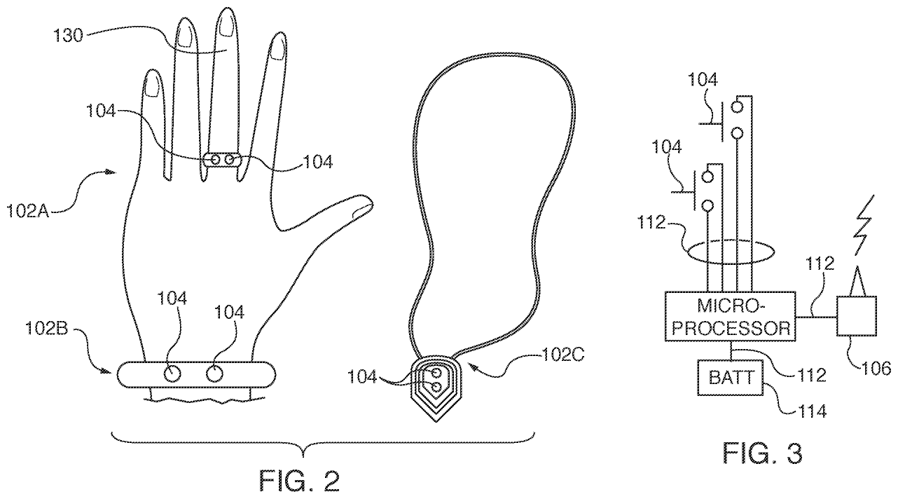

Referring to FIG. 2, in system 100, the body worn input device may comprise at least one of ring 102A wearable on a finger 130 of one of the human subjects, bracelet 102B wearable on an arm 132 of one of the human subjects, or a necklace 102C wearable around a neck (not shown) of one of the human subjects and a pendant (shown with necklace 102C) attachable to a body of one of the human subjects. The body worn input device may of course take a form other than jewelry as illustrated.

In system 100, cellular phone 108 may have downloaded thereinto an application functional to manage dissemination of data received from the body worn input device; and to transfer data from cellular phone 108 to central station 122 and optionally to cloud storage 128.

System 100 may further comprise a self-help facility 132 having stored therein pre-established help data corresponding to recommended actions to be undertaken by the human subject responsive to receipt of transmitted data corresponding to identification of a self-diagnosed mood of the human subject and to self-diagnosed magnitude of the mood, wherein the recommended actions are preloaded into self-help facility 132. Self-help facility 132 includes communications apparatus (not separately shown, but e.g. similar to low powered wireless communications apparatus 106) operable to transmit data corresponding to the recommended actions over the telecommunications network to the personal communications device. Recommended actions may be sent as an audible message, stored as a text message, or as a text image immediately reproducible on a screen of the cellular phone.

The invention may be thought of as a method of capturing, in real time, data pertaining to transient emotions, and transmitting this data remotely for compilation and analysis of a plurality of human subjects. The method may comprise steps of providing each human subject with the body worn input device operable by haptic manipulation (e.g., ring 102A); having at least several of the human subjects manipulate a first interface element (e.g., pushbutton 104) on the body worn input device to record a nature of an emotion, and subsequently manipulate a second interface element (e.g., a second pushbutton 104) on the body worn input device, intensity characteristics of the emotion; responsive to manipulation of the first interface element and the second interface element, automatically wirelessly transmitting data corresponding to inputted nature and intensity characteristics to a personal communications device (e.g., cellular phone 108) in the vicinity of each of the human subjects by a low powered transmission protocol (e.g., Bluetooth); and, responsive to transmitting of data from each of the body worn input devices, automatically and wirelessly transmitting received data to a central station using a communications network. The method further comprises steps of recording received data of the plurality of the human subjects at central station 128; and subsequently transmitting received data of the plurality of human subjects to at least one analyst (represented by PC 124 and cellular phone 126), wherein the subsequently transmitted received data is transmitted using block chain protection and with identities of at least some of the human subjects withheld from the at least one analyst.

In the method, the body worn input device may comprise at least one of ring 102A wearable on a finger of one of the human subjects, bracelet 102B wearable on an arm of one of the human subjects, and the necklace wearable around a neck of one of the human subjects, and the pendant (the necklace and pendant are collectively labeled 102C) attachable to a body of one of the human subjects.

The first interface element and the second interface element may each comprises pushbutton 104 accessible from an outer surface of the respective first interface element or second interface element.

The personal communications device may comprise cellular phone 108 or other data handling device having wireless connection to the telecommunications network. Cellular phone 108 (or another other data handling device) may have downloaded thereinto an application functional to manage dissemination of data received from the body worn input device. In the method, wherein the personal communications device comprises a cellular phone having downloaded thereinto an application functional to manage dissemination of data received from the body worn input device, the method may include a further step of managing data transfer from cellular phone 108 (or other data handling device) to the at least one analyst (represented by PCs 124 and cellular phone 126 in FIG. 1) by the application.

The at least one analyst may comprise a personal counselor having a pre-established consulting relationship with at least one of the human subjects. The method may comprise a further step of establishing ability and authority of the at least one analyst to communicate with the at least one human subject responsively to receiving data corresponding to inputted nature and intensity characteristics.

The method utilizing the apparatus of system 100 may further comprise self-help facility 132 (FIG. 1) having stored therein pre-established data pertaining to recommended actions to be undertaken by the human subject, wherein the recommended actions are personal instructions established to cope with adverse effects of the transient emotions. The method may comprise a further step of transmitting from the self-help facility to mobile phone 108 of the human subject the recommended actions responsively to receiving the data pertaining to transient emotions from the human subject.

The method may further comprise distributing the data of the plurality of the human subjects received at central station 122 to remote third parties for the purpose of academic and scientific study of groups.

Where data is distributed to the remote third parties, the method may further comprise a step of graphically presenting on a screen of at least one of the remote third parties an identity of each of the human subjects as an avatar 134A (FIG. 1), whereby a particular individual can be referred to by one of the third parties while still preserving anonymity of each of the human subjects. Where the personal counselor engages in a study of a plurality of the human subjects, an avatar 134B may designate the person counseled by the personal counselor. In this situation, avatar 134B may identify the human subject, as the latter is already known to the personal counselor.

The method may comprise a further step of presenting the data of the plurality of the human subjects as graphs to at least one of the analysts and the third parties (e.g., on screens of PCs 124A and cellular phone 126), whereby specific characteristics of the transient emotions are graphically displayed in a readily assimilated format for the analysts and the third parties.

The method may further comprise a step of authorizing the third parties to initiate access to the data of the plurality of the human subjects.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A method of capturing, in real time, data pertaining to transient emotions, and transmitting the data remotely for compilation and analysis of a plurality of human subjects, the method comprising:
providing each human subject with a body worn input device operable by haptic manipulation;
having at least several of the human subjects manipulate a first interface element on the body worn input device to record a nature of an emotion, and subsequently manipulate a second interface element on the body worn input device, intensity characteristics of the emotion;
responsive to manipulation of the first interface element and the second interface element, automatically wirelessly transmitting data corresponding to inputted nature and intensity characteristics to a personal communications device in the vicinity of each of the human subjects by a low powered transmission protocol;
responsive to transmitting of data from each of the body worn input devices, automatically and wirelessly transmitting received data to a central station using a communications network;
recording received data of the plurality of the human subjects at the central station; and
subsequently transmitting received data of the plurality of human subjects to at least one analyst, wherein the subsequently transmitted received data is transmitted using block chain protection and with identities of at least some of the human subjects withheld from the at least one analyst.

2. The method of claim 1, wherein the personal communications device comprises a cellular phone having downloaded thereinto an application functional to manage dissemination of data received from the body worn input device, and the method includes a further step of managing data transfer from the cellular phone to the at least one analyst by the application.

3. The method of claim 1, wherein the at least one analyst comprises a personal counselor having a pre-established consulting relationship with at least one of the human subjects, and the method comprises a further step of establishing ability and authority of the at least one analyst to communicate with the at least one human subject responsively to receiving data corresponding to inputted nature and intensity characteristics.

4. The method of claim 1, further comprising a self-help facility having stored therein pre-established data pertaining to recommended actions to be undertaken by the human subject, wherein the recommended actions are personal instructions established to cope with adverse effects of the transient emotions, and the self-help facility transmits the recommended actions to the mobile phone of the human subject responsively to receiving the data pertaining to transient emotions from the human subject.

5. The method of claim 1, further comprising distributing the data of the plurality of the human subjects received at the central station to remote third parties for the purpose of academic and scientific study of groups.

6. The method of claim 5, comprising a further step of graphically presenting on a screen of at least one of the analysts and the remote third parties an identity of each of the human subjects as an avatar, whereby a particular individual can be referred to by a third party analyst while still preserving anonymity of each of the human subjects.

7. The method of claim 5, comprising a further step of presenting the data of the plurality of the human subjects as graphs to at least one of the analysts and the third parties, whereby specific characteristics of the transient emotions are graphically displayed in a readily assimilated format for the analysts and the third parties.

8. The method of claim 5, further comprising authorizing the third parties to initiate access to the data of the plurality of the human subjects.

9. A system for implementing a method of capturing, in real time, data pertaining to transient emotions, and transmitting this data remotely for compilation and analysis for a plurality of human subjects, the system comprising:
for each of the human subjects, a body worn input device operable by haptic manipulation, the body worn input device including:
a first interface element on the body worn input device operable to record a nature of an emotion,
a second interface element on the body worn input device, operable to record intensity characteristics of the emotion,
a low powered wireless communications apparatus operable to transmit data to a cellular phone,
circuitry connecting the first interface element and the second interface element to the low powered wireless communications apparatus, and
a battery cell electrically connected to supply operating power to the circuitry;
a personal communications device operable to communicate via a telecommunications network;
a central station communicably connected to the communications network and having a microprocessor and a memory operable to record data received from each of the personal communications devices, to receive requests, authenticate authorization of a source of each of the requests, and to transmit data through the telecommunications network with block chain protection;
at least one communications device in communication with the telecommunications network and capable of generating a said request for data.

10. The system of claim 9, wherein the body worn input device comprises at least one of a ring wearable on a finger of one of the human subjects, a bracelet wearable on an arm of one of the human subjects, a necklace wearable around a neck of one of the human subjects, and a pendant attachable to a body of one of the human subjects.

11. The system of claim 9, wherein the first interface element and the second interface element each comprises a respective pushbutton accessible from an outer surface of the body worn input device.

12. The system of claim 9, wherein the personal communications device comprises a cellular phone.

13. The system of claim 9, further comprising cloud storage in communication with the central station, and the cellular phone has downloaded thereinto an application functional to manage dissemination of data received from the body worn input device, and to transfer the data received from the body worn input device to the cloud storage.

14. The system of claim 9, wherein the cellular phone has downloaded thereinto an application functional to manage dissemination of data received from the body worn input device; and to transfer data from the cellular phone to at least one of the central station and the cloud storage.

15. The system of claim 9, further comprising a self-help facility having stored therein pre-established help data corresponding to recommended actions to be undertaken by the human subject responsive to receipt of transmitted data corresponding to identification of a self-diagnosed mood of the human subject and to self-diagnosed magnitude of the mood, wherein the recommended actions are preloaded into the self-help facility, and the self help facility includes communications apparatus operable to transmit data corresponding to the recommended actions over the telecommunications network to the personal communications device.
